(19) United States
(12) Patent Application Publication
(10) Pub. No.: US 2014/0064623 A1
(43) Pub. Date: Mar. 6, 2014

(54) IMAGE FEATURE EXTRACTION APPARATUS AND IMAGE FEATURE EXTRACTION METHOD, AND IMAGE PROCESSING SYSTEM USING THE SAME

(71) Applicant: SAMSUNG ELECTRO-MECHANICS CO., LTD., Suwon (KR)

(72) Inventors: Jin Yong Kang, Suwon (KR); Kyoung Joong Min, Suwon (KR)

(73) Assignee: SAMSUNG ELECTRO-MECHANICS CO., LTD., Suwon (KR)

(21) Appl. No.: 13/673,314

(22) Filed: Nov. 9, 2012

(30) Foreign Application Priority Data
Sep. 5, 2012 (KR) 10-2012-0098446

(51) Int. Cl. G06K 9/46

(52) U.S. Cl. CPC G06K 9/46
USPC 382/195

(57) ABSTRACT

There is provided an image feature extraction technology capable of more efficiently processing images by optimizing a scanning region of images. An image feature extraction apparatus includes an image size detecting unit detecting the overall size of an input image; an interest region detecting unit detecting at least one region of interest including objects present in the input image; and a control unit comparing a summed size of the at least one region of interest with the overall size of the input image to determine a scanning region in which feature extraction is to be formed.

### CROSS-REFERENCE TO RELATED APPLICATIONS

This application claims the priority of Korean Patent Application No. 10-2012-0098446 filed on Sep. 5, 2012, in the Korean Intellectual Property Office, the disclosure of which is incorporated herein by reference.

### BACKGROUND OF THE INVENTION

1. Field of the Invention

The present invention relates to an image feature extraction technology capable of more efficiently processing images by optimizing a scanning region thereof.

2. Description of the Related Art

With the development of imaging technologies, various types of image processing have been used in various industrial fields.

In image processing, desired processing is performed by extracting features from image data and sorting the extracted features.

However, in image processing according to the related art, in particular, image feature extraction technology performs the feature extraction on an entire image, such that a considerable amount of time and resources for feature extraction may be consumed. Therefore, there is a problem in that a processing speed of the entire image may be delayed and the processing may be inaccurately performed under the environment in in which the amount of resources is small, and the like.

The following related art document relates to a method for recognizing an obstacle for a vehicle but does not disclose the contents of efficiently processing an image by optimizing a scanning region.

### [Related Art Document]

Korean Patent Laid-Open Publication No. 2012-0055306

### SUMMARY OF THE INVENTION

An aspect of the present invention provides an image feature extraction apparatus, an image feature extraction method, and an image processing system using the same, capable of efficiently processing an image by optimizing a scanning region of an image.

According to an aspect of the present invention, there is provided an image feature extraction apparatus, including: an image size detecting unit detecting the overall size of an input image; an interest region detecting unit detecting at least one region of interest including objects present in the input image; and a control unit comparing a summed size of the at least one region of interest with the overall size of the input image to determine a scanning region in which feature extraction is to be formed.

The control unit may determine the entire input image to be the scanning region when the summed size of the at least one region of interest is larger than the overall size of the input image.

The control unit may determine the at least one region of interest to be the scanning region when the summed size of the at least one region of interest is smaller than the overall size of the input image.

The interest region detecting unit may include: an edge extraction module detecting at least one edge of the input image; and an interest region selection module selecting the region of interest based on the at least one detected edge.

The interest region detecting unit may include: an edge extraction module detecting at least one edge of the input image; an interest block extraction module extracting at least one block of interest from the input image based on the at least one detected edge; and an interest region selection module selecting the region of interest using at least a portion of the at least one block of interest.

The image feature extraction apparatus may further include: a feature extraction unit extracting features of the determined scanning region.

The feature extraction unit may perform the scan on the at least one region of interest to extract the features when the scanning region includes the at least one region of interest.

The feature extraction unit may perform the scan by considering at least portions of overlapping regions of interest to be a single region of interest when the scanning region includes a plurality of regions of interest and at least portions of the plurality of regions of interest overlap each other.

According to another aspect of the present invention, there is provided an image processing system, including: an image feature extraction apparatus extracting a plurality of features present in an input image; and a sorter sorting the plurality of features to sort at least one object within the input image, wherein the image feature extraction apparatus includes: an image size detecting unit detecting the overall size of the input image; an interest region detecting unit detecting at least one region of interest including objects present in the input image; and a control unit comparing a summed size of the at least one region of interest with the overall size of the input image to be subjected to feature extraction.

According to another aspect of the present invention, there is provided an image feature extraction method for use in an image feature extracting apparatus, including: (a) detecting the overall size of an input image; (b) detecting at least one region of interest including objects present in the input image; and (c) comparing a summed size of the at least one region of interest with the overall size of the input image to determine a scanning region in which feature extraction is to be formed.

Operation (c) may include determining the entire input image to be the scanning region, when the summed size of the at least one region of interest is larger than the overall size of the input image

Operation (c) may include determining the at least one region of interest to be the scanning region, when the summed size of the at least one region of interest is smaller than the overall size of the input image.

Operation (b) may include: detecting at least one edge of the input image; and selecting the region of interest based on the at least one detected edge.

Operation (b) may include: detecting the at least one edge of the input image; extracting at least one block of interest from the input image based on the at least one detected edge; and selecting regions of interest using at least a portion of the at least one block of interest.

The image feature extraction method may further include: (d) extracting features of the determined scanning region.

Operation (d) may include, when the scanning region includes the at least one region of interest, extracting features by performing scanning on each of the at least one region of interest.

Operation (d) may further include, when the scanning region includes a plurality of regions of interest and at least portions of the plurality of regions of interest overlap each other, performing the scanning by considering the at least a portions of overlapping regions of interest to be a single region of interest.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a reference diagram for describing a feature extraction method based on a sliding method;

FIG. 2 is a reference diagram for describing the feature extraction method using a region of interest;

FIG. 3 is a reference diagram illustrating an example of the feature extraction using the region of interest;

FIG. 4 is a block diagram illustrating an image feature extraction apparatus according to an embodiment of the present invention;

FIG. 5 is a detailed block diagram illustrating an embodiment of an interest region detecting unit of FIG. 4;

FIG. 6 is a detailed block diagram illustrating another embodiment of the interest region detecting unit of FIG. 4;

FIG. 7A is a reference diagram illustrating an example of image feature extraction according to an embodiment of the present invention;

FIG. 7B is a reference diagram illustrating another example of image feature extraction according to an embodiment of the present invention;

FIG. 8 is a block diagram illustrating an image processing system according to an embodiment of the present invention;

FIG. 9 is a flow chart illustrating an image feature extraction method according to an embodiment of the present invention; and

FIG. 10 is a detailed flow chart of a process of detecting a region of interest of FIG. 9.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Identification signs (for example, a, b, c, and the like) of each operation used below are used for convenience of explanation and therefore, do not refer to a sequence of each operation. Therefore, each operation may be performed differently from a specified order unless a specific order is explicitly described in contexts. That is, each operation may be performed identically to the specified order and may be substantially performed simultaneously or may be performed reversely.

In the drawings, the shapes and dimensions of elements may be exaggerated for clarity, and the same reference numerals will be used throughout to designate the same or like elements.

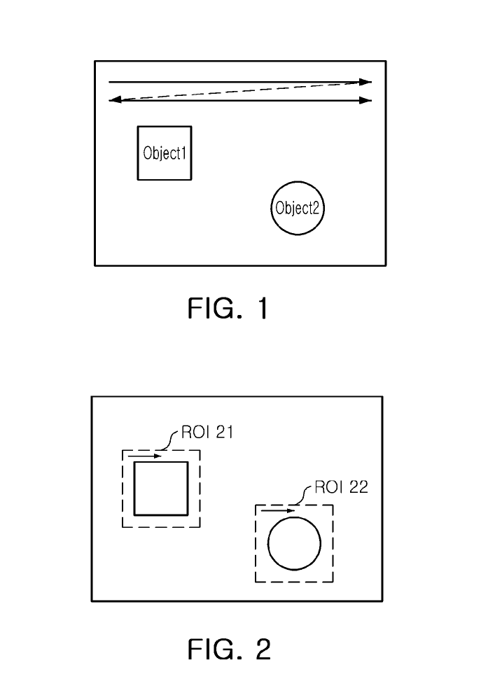

FIG. 1 is a reference diagram for describing a feature extraction method based on a sliding method.

As illustrated in FIG. 1, a sliding method is a method for scanning the entire input image based on a sliding method to detect objects and the like within the input image. For example, the sliding method may detect pixels from an upper left to a lower right of the input image to extract feature.

The sliding method may scan the entire region of the input image and therefore, can relatively accurately detect the objects within the image. However, the sliding method needs to scan the entire region of the input image, such that it takes relatively much time to perform a computation.

Further, the sliding method may have low efficiency as the number of objects (object 1 and object 2) included in the input image is relatively small as illustrated in FIG. 1.

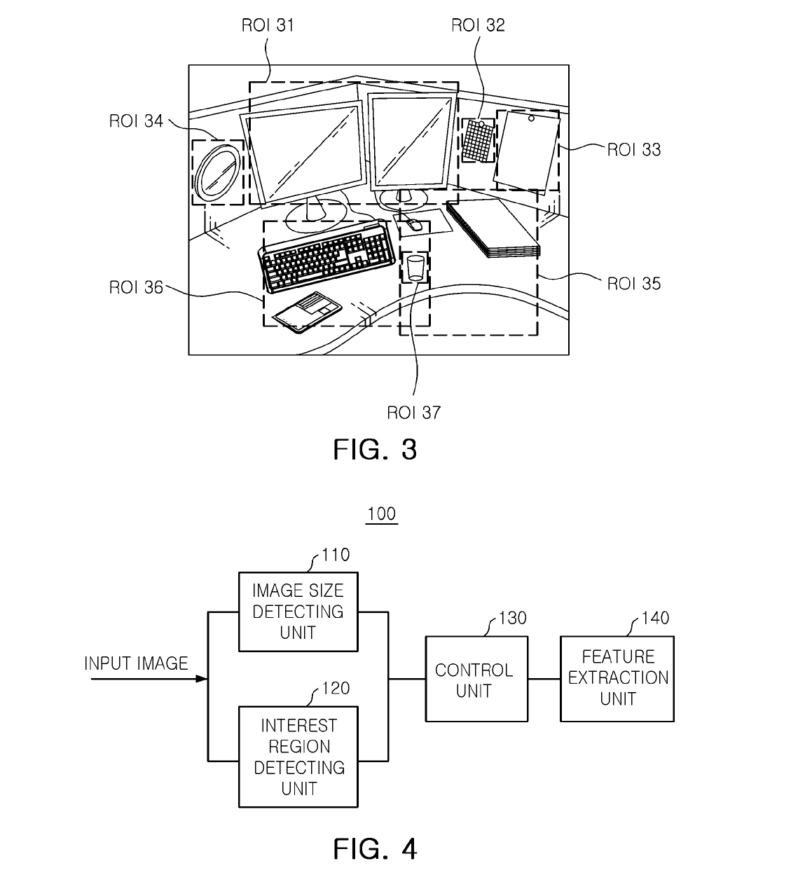

FIG. 2 is a reference diagram for describing the feature extraction method using a region of interest and FIG. 3 is a reference diagram illustrating an example of the feature extraction using the region of interest.

The method using the region of interest may perform pre-processing on the input image to select a region of interest (ROI) and scan the selected region of interest to extract a feature to detect an object. That is, as illustrated in FIG. 2, when regions of interest ROI 21 and ROI 22 are detected, an object may be detected by only scanning the detected regions of interest ROI 21 and ROI 22, respectively.

The method using the region of interest may be performed faster when the region in which an object is present is accurately selected as the ROI. That is, the method using the region of interest only performs the scan on the region of interest without scanning the entire input image to reduce a computational amount, such that the method using the region of interest may be performed faster.

However, the method using the region of interest rather may increase the computational amount when the region of interest is widely detected, to thus degrade efficiency.

Referring to an example of FIG. 3, it can be appreciated that several regions of interest ROI 31 to ROI 37 are captured and a size of the region of interest is generally increased due to an inter-object interference and the like. For example, when many targeted objects are distributed in the input image or noise or light reflection occurs, the region of interest may be increased or a phenomenon of overlapping the regions of interest ROI 35 and ROI 37, and the like, may occur.

In FIG. 3, it can be appreciated that a range of the regions of interest ROI 31 to ROI 37 is shown to be larger than the entire input image and therefore, it can be appreciated that an area on which the scan is performed on the region of interest is larger than an area on which the entire image is scanned by the sliding method. Therefore, in the case of FIG. 3, it can be appreciated that the method using the region of interest needs the more computational amount and has the reduced efficiency, as compared to the scan method.

FIG. 4 is a block diagram illustrating an image feature extraction apparatus according to an embodiment of the present invention.

An image feature extraction apparatus 100 may extract features by using a relatively more efficient method that compares the size of the regions of interest of the input image with the size of the entire input image.

Described in more detail with reference to FIG. 4, the image feature extraction apparatus 100 may include an image size detecting unit 110, an interest region detecting unit 120, and a control unit 130. In the embodiment, the image feature extraction apparatus 100 may further include a feature extraction unit 140.

The image size detecting unit 110 may detect the overall size of an input image. Here, the detection method of the image size detecting unit 110 is not limited to a specific method. For example, the image size detecting unit 110 may confirm the number of horizontal and vertical pixels of the input image to calculate the overall size of input image. As another example, the image size detecting unit 110 may detect the overall size of the input image based on the information (for example, metadata or header information, and the like) on the input image.

The interest region detecting unit 120 may detect at least one region of interest (ROI) that includes an object present in the input image.

The interest region detecting unit 120 may perform the predetermined pre-processing on the input image to detect the region of interest (ROI). The interest region detecting unit 120 may use various ROI detection algorithms and therefore, the present invention is not limited to the detailed ROI detection algorithm.

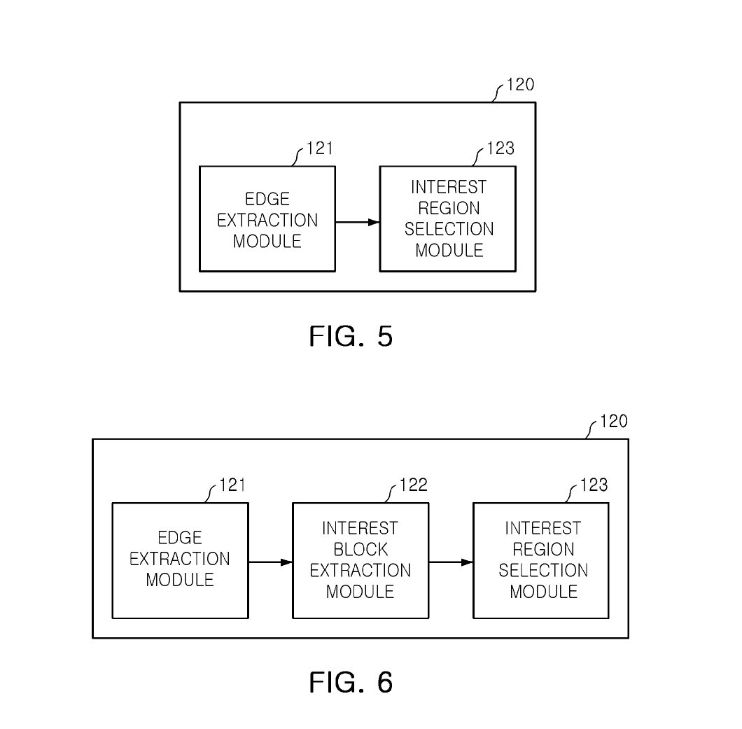

Various embodiments of the interest region detecting unit 120 will be described in detail below with reference to FIGS. 5 and 6.

The control unit 130 may control other components of the image feature extraction apparatus 100.

The control unit 130 may compare the summed size of the regions of interest with the overall size of input image to determine the scanning region in which the feature extraction is performed. That is, the control unit 130 may compare the overall size of input image detected by the image size detecting unit 110 with the summed size of at least one region of interest detected by the interest region detecting unit 120 to determine the scanning region in which the feature extraction is performed.

This may be represented by the following Equation 1.

$$TA = {\sum }_{m = 1}^{n} {A}_{m} \qquad Equation 1$$

In the above Equation 1, when the region of interest refers to ROI 1, ROI 2 to ROI n, an area of each ROI is A1, A2 to An. In addition, TA is the summed size of the regions of interest.

Therefore, the control unit 130 may compare the TA with the overall size of input image to perform the scan on the entire input image when it is determined that the TA is larger than the overall size of input image and to perform the scan on the regions of interest when it is determined that the TA is smaller than the overall size of input image.

In the embodiment, the control unit 130 may obtain respective sizes of the at least one or more regions of interest provided from the interest region detecting unit 120 and then, may sum the obtained sizes to determine the summed size of the regions of interest.

In another embodiment, the control unit 130 may provide at least one or more regions of interest, provided from the interest region detecting unit 120, to the image size detecting unit 110 so as to determine the summed size of the regions of interest by using the image size detecting unit 110.

In the embodiment, the control unit 130 may determine the entire input image to be the scanning region when the summed size of at least one or more regions of interest is larger than the overall size of input image. This case corresponds to the case in which the overall summed size of the regions of interest is larger than the overall size of input image and therefore, the control unit 130 may extract features by only performing the scanning on the entire input image without using the regions of interest. Therefore, the control unit 130 may control the input image by using the sliding method as described above with reference to FIG. 1.

In another embodiment, the control unit 130 may determine at least one region of interest to be the scanning region when the summed size of at least one or more regions of interest is smaller than the overall size of input image. The case corresponds to the case in which the region of interest is in a relatively smaller range than the input image and therefore, the control unit 130 may only perform the scan on the region of interest to extract features. Therefore, the control unit 130 may control the input image to only perform the scan on the ROI as described above with reference to FIG. 2.

The feature extraction unit 140 may extract features by setting the scanning region determined by the control unit 130 as a target.

In one embodiment, the feature extraction unit 140 may individually perform the scan on each of the regions of interest when the region of interest is included in the scanning region to thus extract features.

In another embodiment, when the scanning region includes a plurality of regions of interest and at least a portion of the plurality of regions of interest overlap each other, the feature extraction unit 140 may perform the scan by considering at least portions of the overlapping regions of interest to be a single region of interest.

FIG. 5 is a detailed block diagram illustrating an embodiment of an interest region detecting unit of FIG. 4.

The interest region detecting unit 120 illustrated in FIG. 5 refers to the embodiment of extracting an edge of the input image and selecting the regions of interest using the extracted edges.

Described in more detail with reference to FIG. 5, the interest region detecting unit 120 may include an edge extraction module 121 and an interest region selection module 123.

The edge extraction module 121 may detect at least one edge of the input image.

The edge may be a portion in which brightness is suddenly changed in the image and the edge may be frequently shown at a corner portion of an object.

In the embodiment, the edge extraction module 121 may use first derivation to extract the edges. For example, the edge extraction module 121 may use Prewitt, Roberts, Sobel, and the like, or combine them to extract the edges.

In the embodiment, the edge extraction module 121 may extract a horizontal edge, a vertical edge, or a diagonal edge of the input image.

The interest region selection module 123 may select the region of interest based on at least one edge detected by the edge extraction module 121.

In the embodiment, the region of interest select module 123 may extract candidate regions using at least one edge detected by the edge detection module 121 and then, apply a wavelet transform to the candidate regions so as to be selected as the region of interest.

FIG. 6 is a detailed block diagram illustrating another embodiment of the interest region detecting unit of FIG. 4.

The interest region detecting unit 120 illustrated in FIG. 6 refers to the embodiment of extracting the edges of the input image, extracting a block of interest using the extracted edges, and selecting the region of interest based on the extracted block of interest.

Described in more detail with reference to FIG. 6, the interest region detecting unit 120 may further include an interest block extraction module 122 in addition to the configuration of FIG. 5. Therefore, the same contents as the contents described in FIG. 5 or the contents corresponding thereto are not repeatedly described.

The interest block extraction module 122 may extract at least one block of interest from the input image, based on at least one edge detected by the edge extraction module 121.

In the embodiment, the interest block extraction module 122 may divide the image only formed of the extracted edges into a predetermined number of blocks (for example, 32×32, 64×64, and the like) having the same size and then, perform the scan on the plurality of blocks to determine the block of interest.

Here, the interest block extraction module 122 may determine, as a background block, the edge blocks having edge information amount smaller than a threshold value.

The interest region selection module 123 may select the region of interest by using at least a portion of the at least one block of interest that is extracted from the interest block extraction module 122.

In one embodiment, when the overlapping regions of interest are present, the interest region selection module 123 may determine the overlapping regions of interest to be a single region of interest. Described in more detail, when the plurality of regions of interest at least partially overlap, the interest region selection module 123 may consider at least a portion of the overlapping regions of interest to be a single region of interest.

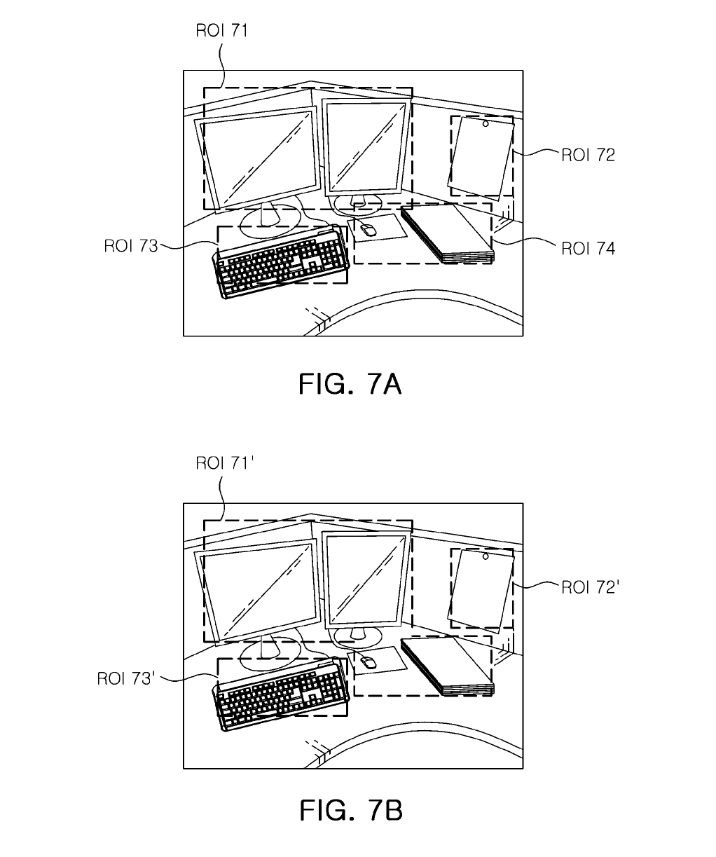

FIGS. 7A and 7B are reference diagrams illustrating an example of image feature extraction according to the embodiment of the present invention. As described above, according to the embodiment of the present invention, the overlapping regions of interest may be set or considered to be a single region of interest.

In the case of the embodiment of the foregoing feature extraction unit 140, it is confirmed whether the overlapping regions of interest occurs based on the scanning region determined by the control unit 130, and when the overlapping occurs, the overlapping regions of interest may be considered to be one to extract features. That is, as illustrated in FIG. 7A, when the scanning region includes the regions of interest ROI 71, ROI 72, ROI 73, and ROI 74 and when the ROI 71 and ROI 74 partially overlap each other, the feature extraction unit 140 may perform the feature extraction by considering the ROI 71 and ROI 74 to be a single region of interest ROI 71′ as illustrated in FIG. 7B.

Meanwhile, in the case of the embodiment of the foregoing interest region selection module 123, when the overlapping regions of interest ROI 71 and ROI 74 are present, the overlapping regions of interest ROI 71 and ROI 74 may be combined as a single region of interest so as to be set as ROI 71′. Therefore, in this case of the embodiment, the region of interest provided to the control unit 130 may not be the state illustrated in FIG. 7A, but may be the state illustrated in FIG. 7B.

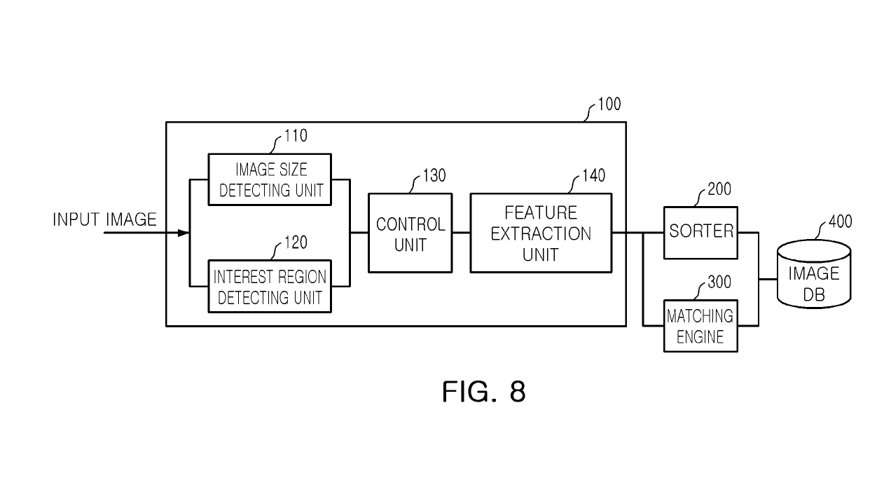

FIG. 8 is a block diagram illustrating an image processing system according to an embodiment of the present invention.

Referring to FIG. 8, the image processing system may include an image feature extraction apparatus 100 and a sorter 200. In one embodiment, the image processing system may further include a matching engine 300 or an image database 400.

The image feature extraction apparatus 100 may extract a plurality of features that are present in the input image. Here, the image feature extraction apparatus 100 is the same as in the contents described with reference to FIGS. 4 to 7 and the detailed description thereof will be omitted.

The sorter 200 may sort the plurality of features to sort at least one object within the input image.

The matching engine 300 may use the sorted object to match the plurality of input images.

The image database 400 may store the input images and the feature information thereof.

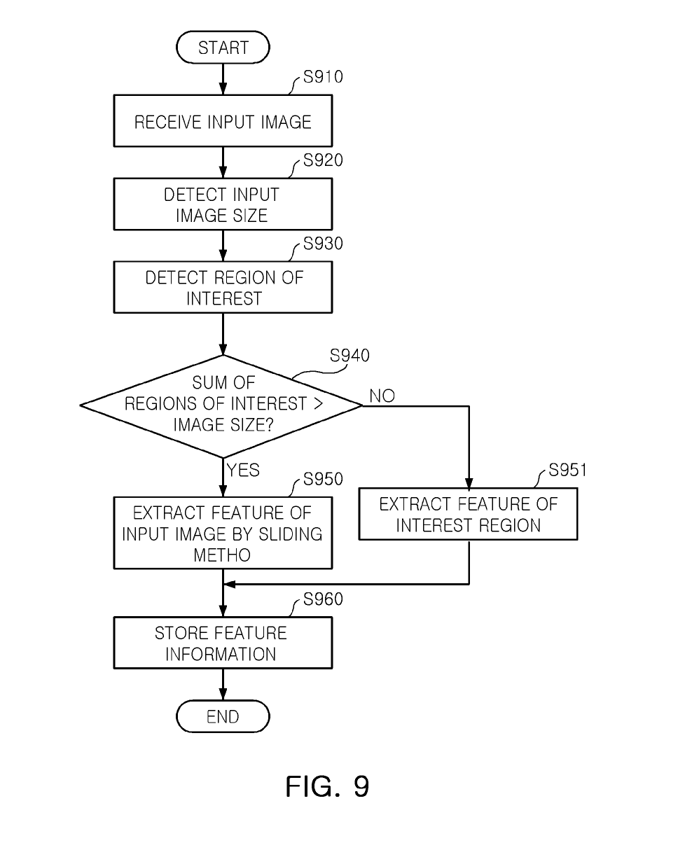

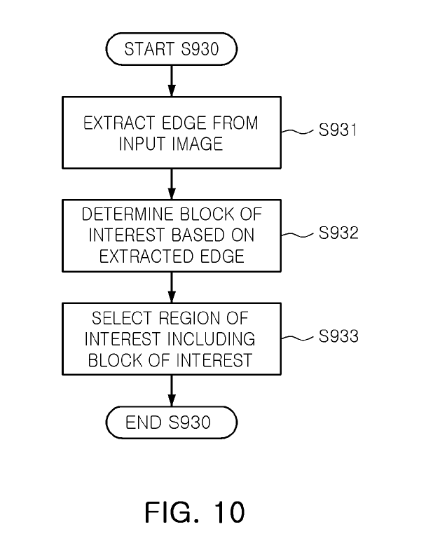

FIG. 9 is a flow chart illustrating an image feature extraction method according to an embodiment of the present invention and FIG. 10 is a detailed flow chart of a process of detecting a region of interest of FIG. 9.

Hereinafter, the image feature extraction method according to the embodiment of the present invention will be described with reference to FIGS. 9 and 10. However, the image feature extraction method is performed in the foregoing image feature extraction apparatus 100 and the same contents as the foregoing contents or the contents corresponding thereto will not be repeatedly described with reference to FIGS. 1 to 8.

Referring to FIG. 9, the image feature extraction apparatus 100 may receive the input image (S910) and detect the overall size of input image (S920).

The image feature extraction apparatus 100 may detect at least one region of interest including the objects present in the input image (S930) and compare the summed size of at least one region of interest with the overall size of input image (S940).

When the summed size of the region of interest is larger than the overall size of input image (‘YES’ in S940), the image feature extraction apparatus 100 may extract features of the input image by the sliding method.

On the other hand, when the summed size of the region of interest is smaller than the overall size of input image (‘NO’ in S940), the image feature extraction apparatus 100 may extract features of the region of interest.

In the embodiment, the image feature extraction apparatus 100 may determine the scanning region to extract the features. That is, the image feature extraction apparatus 100 sets the predetermined region in which the features are extracted, to be the scanning region, and sets the region of interest or any one region of the entire image to be the scanning region to thus extract the features.

In one embodiment, when the scanning region includes at least one region of interest, the image feature extraction apparatus 100 may perform the scan on each of at least one region of interest to extract the features.

Here, when the scanning region includes a plurality of regions of interest and at least portions of the plurality of regions of interest overlap each other, the image feature extraction apparatus 100 may perform the scan by considering at least portions of the overlapping regions of interest to be a single region of interest.

The detecting of the region of interest (S930) may include using the edge information.

Described in more detail with reference to FIG. 10, the image feature extraction apparatus 100 may detect at least one edge of the input image (S931). The image feature extraction apparatus 100 may extract at least one block of interest from the input image based on at least one detected edge (S932) and select the region of interest using at least a portion of at least one block of interest (S933).

As set forth above, the image may be more efficiently processed by optimizing the scanning region of the image.

While the present invention has been shown and described in connection with the embodiments thereof, it will be apparent to those skilled in the art that modifications and variations can be made without departing from the spirit and scope of the invention as defined by the appended claims.

What is claimed is:

1. An image feature extraction apparatus, comprising:
an image size detecting unit detecting the overall size of an input image;
an interest region detecting unit detecting at least one region of interest including objects present in the input image; and
a control unit comparing a summed size of the at least one region of interest with the overall size of the input image to determine a scanning region to be subjected to feature extraction.

2. The image feature extraction apparatus of claim 1, wherein the control unit determines the entire input image to be the scanning region when the summed size of the at least one region of interest is larger than the overall size of the input image.

3. The image feature extraction apparatus of claim 1, wherein the control unit determines the at least one region of interest to be the scanning region when the summed size of the at least one region of interest is smaller than the overall size of the input image.

4. The image feature extraction apparatus of claim 1, wherein the interest region detecting unit includes:
an edge extraction module detecting at least one edge of the input image; and
an interest region selection module selecting the region of interest based on the at least one detected edge.

5. The image feature extraction apparatus of claim 1, wherein the interest region detecting unit includes:
an edge extraction module detecting at least one edge of the input image;
an interest block extraction module extracting at least one block of interest from the input image, based on the at least one detected edge; and
an interest region selection module selecting the region of interest using at least a portion of the at least one block of interest.

6. The image feature extraction apparatus of claim 1, further comprising a feature extraction unit extracting features of the determined scanning region.

7. The image feature extraction apparatus of claim 6, wherein the feature extraction unit performs the scan on the at least one region of interest to extract the features when the scanning region includes the at least one region of interest.

8. The image feature extraction apparatus of claim 6, wherein the feature extraction unit performs the scan by considering at least portions of overlapping regions of interest to be a single region of interest when the scanning region includes a plurality of regions of interest and at least portions of the plurality of regions of interest overlap each other.

9. An image processing system, comprising:
an image feature extraction apparatus extracting a plurality of features present in an input image; and
a sorter sorting the plurality of features to sort at least one object within the input image,
the image feature extraction apparatus includes:
an image size detecting unit detecting the overall size of the input image;
an interest region detecting unit detecting at least one region of interest including objects present in the input image; and
a control unit comparing a summed size of the at least one region of interest with the overall size of the input image to be subjected to feature extraction.

10. An image feature extraction method for use in an image feature extracting apparatus, comprising:
(a) detecting the overall size of an input image;
(b) detecting at least one region of interest including objects present in the input image; and
(c) comparing a summed size of the at least one region of interest with the overall size of the input image to determine a scanning region to be subjected to feature extraction.

11. The image feature extraction method of claim 10, wherein operation (c) includes determining the entire input image to be the scanning region, when the summed size of the at least one region of interest is larger than the overall size of the input image.

12. The image feature extraction method of claim 10, wherein operation (c) includes determining the at least one region of interest to be the scanning region, when the summed size of the at least one region of interest is smaller than the overall size of the input image.

13. The image feature extraction method of claim 10, wherein operation (b) includes:
detecting at least one edge of the input image; and
selecting the region of interest based on the at least one detected edge.

14. The image feature extraction method of claim 10, wherein operation (b) includes:
detecting the at least one edge of the input image;
extracting at least one block of interest from the input image, based on the at least one detected edge; and
selecting regions of interest using at least a portion of the at least one block of interest.

15. The image feature extraction method of claim 10, further comprising (d) extracting features of the determined scanning region.

16. The image feature extraction method of claim 15, wherein operation (d) includes, when the scanning region includes the at least one region of interest, extracting features by performing scanning on each of the at least one region of interest.

17. The image feature extraction method of claim 15, wherein operation (d) further includes:
when the scanning region includes a plurality of regions of interest and at least portions of the plurality of regions of interest overlap each other, performing the scanning by considering the at least portions of overlapping regions of interest to be a single region of interest.
